(19) United States
(12) Patent Application Publication
(10) Pub. No.: US 2008/0140667 A1
(43) Pub. Date: Jun. 12, 2008

(54) DEVICE AND METHOD FOR CREATING A TRANSACTION LOG OF DATA EXCHANGES BETWEEN A PORTABLE MOBILE COMMUNICATIONS DEVICE AND OTHER WIRELESS DEVICES

(75) Inventor: Maurice Jerome LaBiche, Cary, NC (US)

Correspondence Address: MOORE AND VAN ALLEN PLLC FOR SEMC, P.O. BOX 13706, 430 DAVIS DRIVE, SUITE 500, RESEARCH TRIANGLE PARK, NC, 27709, US

(73) Assignee: SONY ERICSSON MOBILE COMMUNICATIONS AB, Lund (SE)

(21) Appl. No.: 11/567,779

(22) Filed: Dec. 7, 2006

(51) Int. Cl. H04B 5/00; G06F 17/30

(52) U.S. Cl. 707/10; 455/41.1; 707/1; 707/E17.044; 707/E17.032

(57) ABSTRACT

Disclosed is a portable mobile communications device and method that can create and store a transaction log of data exchanged over a near field RF communication system. A near field RF communication data transaction is performed. A transaction log record of the just performed near field RF communication data transaction is then created and stored in a transaction log database. A transaction log record is created by obtaining data pertaining to the transaction that uniquely identifies the transaction and its context and filling fields of the transaction log record with the relevant data obtained. The transaction log database is made accessible to the user for review and manipulation.

### BACKGROUND OF THE INVENTION

Portable mobile communications devices such as mobile phones are becoming more sophisticated and include many new features and capabilities. Many portable mobile communications devices include a secondary near field RF transceiver such as, for instance, Bluetooth™ or the like. The near field transceiver is designed to provide device-to-device communications that are limited in range. In essence, near field RF systems are designed to eliminate the need for wires or cables between communicating devices. Examples of use include, wireless headsets, file transfers, electronic commerce, etc.

Many of the use cases involve sharing, sending, receiving or exchanging sensitive personal data. This includes personal financial account data that identify credit cards, debit cards, and perhaps even bank accounts. It would be advantageous to know when such information was sent and to whom in order to verify the integrity of certain transactions. This goal can be achieved with the creation and maintenance of a transaction log. Such a log would allow the portable mobile communications device owner to view detailed data pertaining to transactions to verify that a given transaction was indeed intended.

### BRIEF SUMMARY OF THE INVENTION

Disclosed is a portable mobile communications device, method, and computer program product that can create and store a transaction log of data exchanged over a near field RF communication system. A near field RF communication data transaction is performed by establishing a near field RF communication connection between the portable mobile communications device and another similarly equipped wireless device, exchanging data between the portable mobile communications device and other similarly equipped wireless device over the established near field RF communication connection, and terminating the established near field RF communication connection between the portable mobile communications device and the other similarly equipped wireless device.

A transaction log record of the just performed near field RF communication data transaction is then created and stored in a transaction log database. A transaction log record is created by obtaining data pertaining to the transaction that uniquely identifies the transaction and its context and filling a plurality of fields of the transaction log record with the relevant data obtained. The transaction log database is made accessible to the user for review and manipulation.

The plurality of fields of the transaction log record include universal transaction fields that identify the sending wireless device involved in the data exchange, the receiving wireless device involved in the data exchange, the geographic location of the near field RF communication data transaction, and the date and time of the near field RF communication data transaction.

For commercial transactions, the plurality of fields of the transaction log record also include financial data such as a financial account associated with the near field RF communication data transaction, a monetary amount associated with the near field RF communication data transaction, a field that identifies the vendor associated with the near field RF communication data transaction. A vendor is an entity that sells or otherwise provides goods or services such that a portable mobile communications device can communicate with the “vendor” electronically to purchase or otherwise obtain the goods or services.

For file transactions, the plurality of fields of the transaction log record also include file data such as a field that identifies a transaction file identifier containing data pertaining to a file name identifier, a file type identifier, a file size identifier, and a file location identifier.

### BRIEF DESCRIPTION OF THE DRAWINGS

FIG. 1 is an illustration of a portable mobile communications device and a variety of other wireless devices that can be equipped to communicate with the portable mobile communications device over a near field RF communication system.

FIG. 2 is a block diagram of certain components of a portable mobile communications device according to the present invention.

FIG. 3 is a flowchart illustrating a method for creating a transaction log within the portable mobile communications device that records data exchanges over the near field RF communication system.

FIG. 4 is an illustration of an example of the data contained in a transaction log record.

FIG. 5 is a flowchart illustrating a method of examining and manipulating the records in a transaction log.

### DETAILED DESCRIPTION OF THE INVENTION

The following detailed description of embodiments refers to the accompanying drawings, which illustrate specific embodiments of the invention. Other embodiments having different structures and operations do not depart from the scope of the present invention.

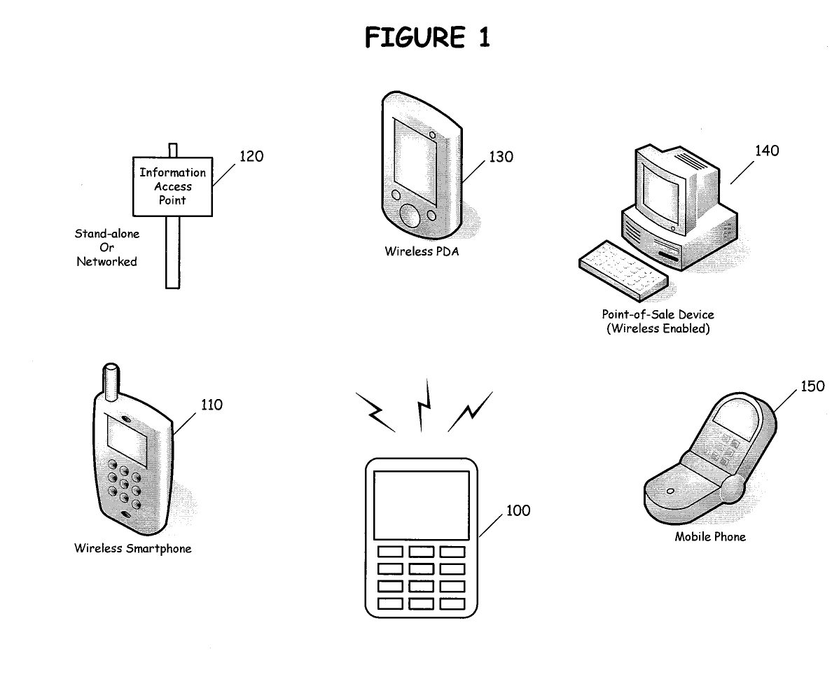

FIG. 1 is an illustration of a portable mobile communications device 100 and a variety of other wireless devices that can be equipped to communicate with the portable mobile communications device over a near field RF communication system. The portable mobile communications device 100 can take a variety of forms including but not limited to, a cellular phone operable on any of the numerous cellular wireless RF protocols including but not limited to, GSM and CDMA. The portable mobile communications device 100 is further equipped with a near field RF communication transceiver such as, for instance, a Bluetooth™ module. Other near field RF communication systems are also compatible and operable with the present invention.

The portable mobile communications device 100 can utilize its near field RF communication transceiver to communicate with other similarly equipped wirelessly enabled devices including, but not limited to, a wireless smartphone 110, a wireless information access point 120, a wireless personal digital assistant (PDA) 130, a wireless enabled point-of-sale (POS) device 140 (e.g., a computerized cash register), and other mobile phones 150. The near field RF communication system becomes operable when the portable mobile communications device 100 is brought into proximity of another similarly equipped device.

In the case of Bluetooth™, upon each device discovering the other, an RF connection can be established that allows data to be exchanged between the two devices. In other near field RF communication systems, one device can simply broadcast data to any device capable of receiving and processing the data and await some type of acknowledgement from the receiving device.

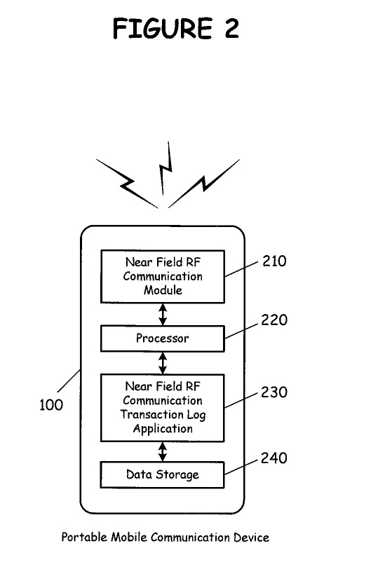

FIG. 2 is a block diagram of certain components of a portable mobile communications device 100 according to the present invention. Illustrated within the portable mobile communications device 100 is a near field RF communication module 210, a processor 220, a near field RF communication transaction log application 230, and data storage 240. The near field RF communication module 210 is used to establish and carry out data exchanges wirelessly over relatively short ranges between the portable mobile communications device 100 and another similarly equipped wireless device. The processor 220 is coupled with the other components and provides the system with computer processing capabilities in order to manage and carry out instructions pertaining to the creation and maintenance of transaction log records in a transaction log. The near field RF communication transaction log application 230 is a software application that is run by the processor 220 and provides the instructions used by the processor 220 to control the creation and maintenance of transaction log records in a transaction log. Data storage 240 provides memory space that is accessible by the processor 220 and the near field RF communication transaction log application 230 and is used to store transaction log records.

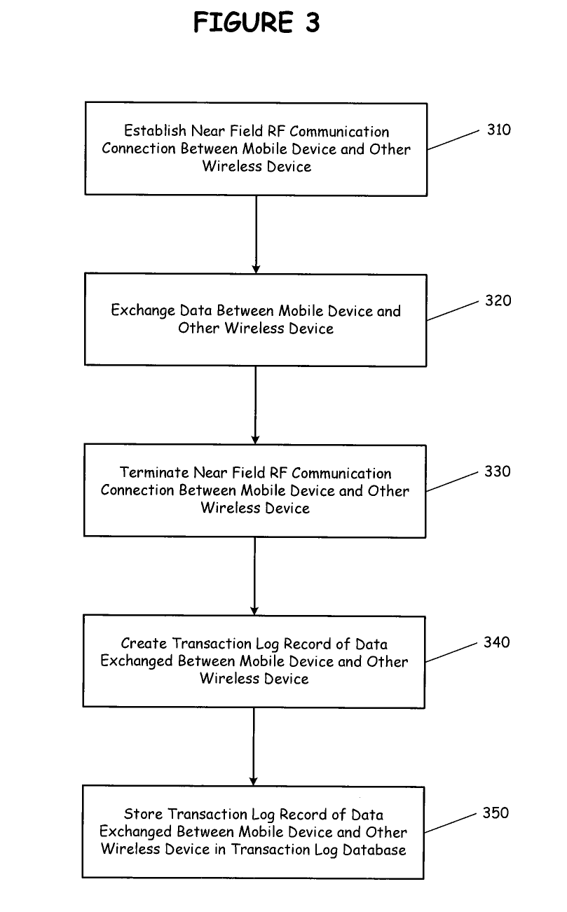

FIG. 3 is a flowchart illustrating a method for creating a transaction log within the portable mobile communications device that records data exchanges over the near field RF communication system. Creating and maintaining a transaction log of data exchanges broadly implies a two step process. The first step is to actually perform a data exchange. The second step is to memorialize aspects of the data exchange in the form of a transaction log record. A collection of transaction log records form an overall database that is referred to as the transaction log.

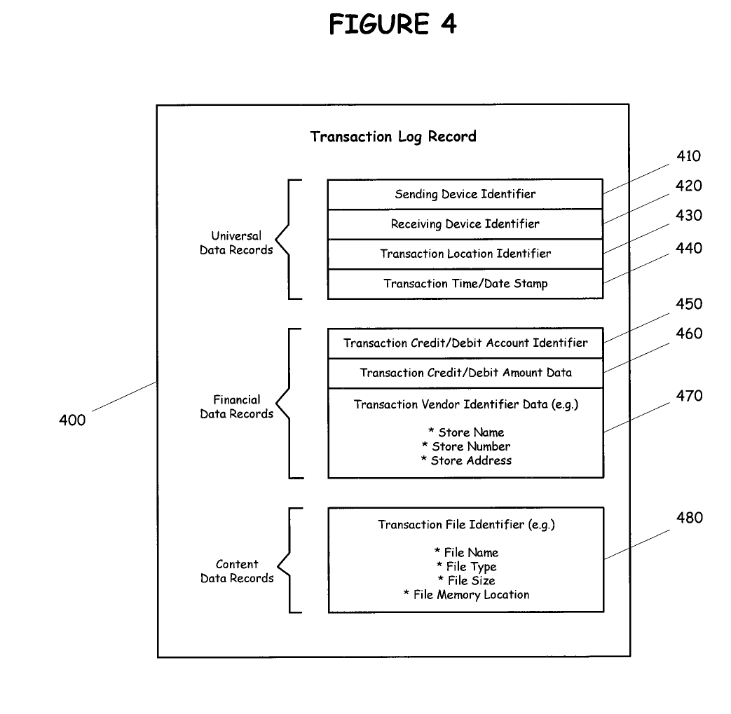

In step 310, a near field RF communication connection is established between the portable mobile communications device 100 and another similarly equipped wireless device. The exact mechanisms of creating this connection are left to the devices themselves and whatever particular near field RF communication system is being utilized. In step 320, data is actually exchanged between the two devices. A data exchange can take many forms depending on the format of the data being exchanged. A typical data exchange identifies one device as a sender and the other device as a receiver. The sending device will package and send data over the near field RF communication system to the receiving device. The receiving device will typically reply with an acknowledgement of sorts indicating the status of the transaction. A device can be a sender, a receiver, or both for a given transaction. In step 330, the near field RF communication connection between the two devices is terminated upon completion of the desired transaction. The three steps just presented constitute the process of exchanging data between the portable mobile communications device 100 and another wireless device. Step 340 describes creating a transaction log record (see, FIG. 4) of data exchanged between the portable mobile communications device 100 and the other wireless device. Lastly, step 350 describes locally storing the just created transaction log record in a transaction log database maintained on the portable mobile communications device 100. The transaction log record is created by gathering data pertaining to the exchange while the exchange is occurring and immediately afterward and is more fully described below.

The transaction log record can also or alternatively be stored remotely on another device to provide a back-up copy of all transaction log records. This can be achieved by sending the just created transaction log record to another device using the cellular RF module to a network storage device within the network infrastructure, a local RF transceiver such as Bluetooth™, an infrared connection, or a direct cable connection.

FIG. 4 is an illustration of an example of the data contained in a transaction log record 400. A transaction log record 400 is comprised of data that provides a context for the data exchange it represents. The record includes many types of fields that can be indexed by the user when later reviewing the transaction log database. There are many reasons for performing a near field RF data exchange. Each data exchange is unique in some way whether it is due to the time/date stamp of the transaction, the content of the data, the geographic location of the transaction, or a unique identifier of the sending and receiving wireless devices. A transaction log record 400 according to the present invention memorializes as much information about a near field RF transaction as it can.

The record about to be described as referring to FIG. 4 is not intended to be all encompassing, however. Others skilled in the art may include additional fields associated with a transaction that are not necessarily contemplated in this disclosure but still fall squarely within the framework of the present invention.

The first four fields illustrated in the transaction log record 400 of FIG. 4 are common to virtually every near field RF transaction because they are focused on device data, time/date stamping, and geographic positional data. This type of data is present for every near field RF transaction. Thus, the transaction log record 400 obtains a sending device identifier 410 and a receiving device identifier 420 that uniquely identify the wireless devices involved in a particular transaction. The transaction log record 400 further includes temporal and special records that record when and where the transaction took place. These are a location identifier 430 and a time/date stamp field 440. The location identifier can be obtained by a GPS type module if the mobile device is so equipped or via some other methodology. If there is no ‘fine’ positioning data available, the transaction log record 400 can at least attach a base station identifier to give a ‘coarser’ idea of the geographic location of the portable mobile communications device 100.

This can be valuable if a dispute arises as to a commercial transaction that is said to have occurred in a location that the portable mobile communications device 100 could not possibly have been in due to the basestation identifier associated with the transaction. While a basestation identifier has nothing to do with the actual transaction, since the near field RF module handles that, it can still provide valuable contextual data about the transaction.

The remaining fields in the transaction log record 400 are more closely associated with the content of the data transaction. For instance, it is becoming more common to use near field RF equipped devices in financial transactions to purchase goods or services from commercial enterprises. In such transactions, the portable mobile communications device 100 is provisioned with financial data such as, for instance, credit card account data, bank account debit card data, and/or specific vendor credit data. During a near field RF commercial transaction, the portable mobile communications device 100 is used to ‘pay’ for goods or services by sending specific financial data to a POS device (see, FIG. 1, reference numeral 140 for instance).

The transaction log record 400 will memorialize aspects of commercial transactions as a way to provide the user a back-up copy of transactions if ever a dispute arises. To that end there is a field for an account identifier 450 that identifies to which financial account the transaction was posted, an amount field 460 that indicates the amount of money was involved in the transaction, and a vendor identification data field 470 that provides as much information about the vendor as can be obtained including, but not limited to, vendor (store) name, store number, store address, sales associate responsible for the transaction, etc.

Another type of near field RF transaction may involve sending and/or receiving data files to/from another wireless device. This type of transaction encompasses exchanging media content files such as, but not limited to, audio files (MP3 or the like), video files (JPEG, MPEG, or the like), text files (e.g., Word, Excel, Powerpoint, etc . . . ), personal files such as contact data from a phonebook database, or the like. For these types of near field RF transactions, the transaction log record 400 will include a transaction file identifier field 480 that identifies things like a file name, a file type, a file size, the local address from which the file was obtained, etc.

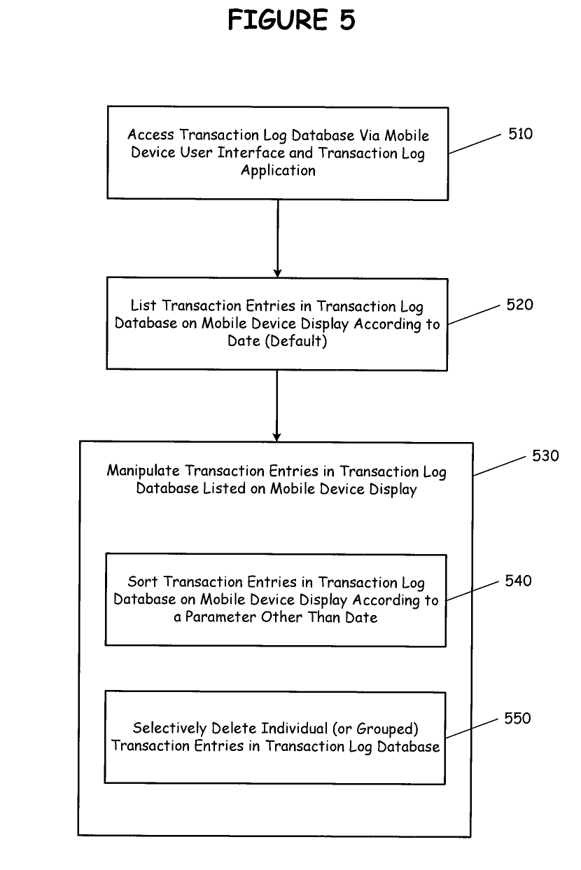

FIG. 5 is a flowchart illustrating a method of examining and manipulating the records in a transaction log. The transaction log itself is a database of individual transaction log records 400 that are stored in data storage component 240 within the portable mobile communications device 100. The near field RF communication transaction log application 230 also provides a means for accessing, reviewing, and manipulating the transaction log records 400 in the transaction log database.

In step 510, the portable mobile communications device user can access the transaction log database via the user interface of the portable mobile communications device 100 and the near field RF communication transaction log application 230. In step 520, a list of the currently saved transaction log records 400 is displayed on the portable mobile communications device display. The default view of the displayed transaction log records 400 is presented according to the date/time stamp field of each transaction log record meaning that the transaction log records 400 on list are displayed from the most recent to the oldest.

In step 530, the list of transaction log records can be manipulated. Two types of transaction log record manipulation are described. In step 540, the user can ‘sort’ the transaction log records according to a field or parameter other than the default (date/time stamp). This allows the list to be reconfigured based on, for instance, vendor name, file name, file type, transaction amount, etc.

Perhaps the user is not sure that a particular transaction that occurred with a particular vendor has been accurately recorded by the vendor in a recently received statement. The user can access the transaction log database and sort the list according to the vendor name in an attempt to match the transaction log record on the portable mobile communications device 100 with the transaction recorded on the statement.

Or, the user can sort the list according to a file name to determine which devices were sent a particular file and when. There are numerous practical sorting scenarios that can be contemplated by a user and performed by the intelligence associated with the present invention.

In step 550, the user is provided the ability to selectively delete individual or grouped transaction records. A purging function can be incorporated into the near field RF communication transaction log application 230 that will purge transaction records that are of a certain age. This feature can be overridden by the user entirely or selectively by setting a parameter for a particular transaction record to be undeletable until otherwise specified.

Those skilled in the art may devise other transaction manipulation scenarios that are not specifically enumerated herein but which fit within the framework provided by the disclosure of the present invention.

As will be appreciated by one of skill in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

Any prompts associated with the present invention may be presented and responded to via a graphical user interface (GUI) presented on the display of the portable mobile communications device or the like.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

1. On a portable mobile communications device, a method of creating a transaction log of data exchanges between a portable mobile communications device and other wireless devices, the method comprising:
performing a near field RF communication data transaction comprising:
establishing a near field RF communication connection between the portable mobile communications device and another similarly equipped wireless device;
exchanging data between the portable mobile communications device and other similarly equipped wireless device over the established near field RF communication connection; and
terminating the established near field RF communication connection between the portable mobile communications device and the other similarly equipped wireless device, and
creating a transaction log record of the just performed near field RF communication data transaction.

2. The method of claim 1 further comprising storing the transaction log record of the just performed near field RF communication data transaction in a transaction log database within the portable mobile communications device.

3. The method of claim 1 further comprising storing the transaction log record of the just performed near field RF communication data transaction in a transaction log database on a remote external storage device.

4. The method of claim 1 wherein creating a transaction log record of the just performed near field RF communication data transaction comprises:
obtaining data pertaining to the just performed near field RF communication data transaction that uniquely identifies the transaction and its context; and
filling a plurality of distinct fields of the transaction log record with the relevant data obtained pertaining to the just performed near field RF communication data transaction.

5. The method of claim 4 wherein the plurality of distinct fields of the transaction log record includes a field that identifies the sending wireless device involved in the data exchange.

6. The method of claim 4 wherein the plurality of distinct fields of the transaction log record include a field that identifies the receiving wireless device involved in the data exchange.

7. The method of claim 4 wherein the plurality of distinct fields of the transaction log record includes a field that identifies the geographic location of the near field RF communication data transaction.

8. The method of claim 4 wherein the plurality of distinct fields of the transaction log record includes a field that identifies the date and time of the near field RF communication data transaction.

9. The method of claim 4 wherein the plurality of distinct fields of the transaction log record includes a field that identifies a financial account associated with the near field RF communication data transaction.

10. The method of claim 4 wherein the plurality of distinct fields of the transaction log record includes a field that identifies a monetary amount associated with the near field RF communication data transaction.

11. The method of claim 4 wherein the plurality of distinct fields of the transaction log record includes a field that identifies the vendor associated with the near field RF communication data transaction.

12. The method of claim 4 wherein the plurality of distinct fields of the transaction log record includes a field that identifies a transaction file identifier associated with the near field RF communication data transaction.

13. The method of claim 12 wherein the field that identifies a transaction file identifier associated with the near field RF communication data transaction includes a file name identifier.

14. The method of claim 12 wherein the field that identifies a transaction file identifier associated with the near field RF communication data transaction includes a file type identifier.

15. The method of claim 12 wherein the field that identifies a transaction file identifier associated with the near field RF communication data transaction includes a file size identifier.

16. The method of claim 12 wherein the field that identifies a transaction file identifier associated with the near field RF communication data transaction includes a file location identifier.

17. On a portable mobile communications device, a computer program product embodied on a computer readable medium for creating a transaction log of data exchanges between a portable mobile communications device and other wireless devices, the computer program product comprising:
computer program code for performing a near field RF communication data transaction comprising:
computer program code for establishing a near field RF communication connection between the portable mobile communications device and another similarly equipped wireless device;
computer program code for exchanging data between the portable mobile communications device and other similarly equipped wireless device over the established near field RF communication connection; and
computer program code for terminating the established near field RF communication connection between the portable mobile communications device and the other similarly equipped wireless device, and
computer program code for creating a transaction log record of the just performed near field RF communication data transaction.

18. The computer program product embodied on a computer readable medium of claim 17 further comprising computer program code for storing the transaction log record of the just performed near field RF communication data transaction in a transaction log database within the portable mobile communications device.

19. The computer program product embodied on a computer readable medium of claim 17 further comprising computer program code for storing the transaction log record of the just performed near field RF communication data transaction in a transaction log database on a remote external storage device.

20. The computer program product embodied on a computer readable medium of claim 17 wherein the computer program code for creating a transaction log record of the just performed near field RF communication data transaction comprises:
computer program code for obtaining data pertaining to the just performed near field RF communication data transaction that uniquely identifies the transaction and its context; and
computer program code for filling a plurality of distinct fields of the transaction log record with the relevant data obtained pertaining to the just performed near field RF communication data transaction.

21. The computer program product embodied on a computer readable medium of claim 20 wherein the plurality of distinct fields of the transaction log record includes a field that identifies the sending wireless device involved in the data exchange.

22. The computer program product embodied on a computer readable medium of claim 20 wherein the plurality of distinct fields of the transaction log record include a field that identifies the receiving wireless device involved in the data exchange.

23. The computer program product embodied on a computer readable medium of claim 20 wherein the plurality of distinct fields of the transaction log record includes a field that identifies the geographic location of the near field RF communication data transaction.

24. The computer program product embodied on a computer readable medium of claim 20 wherein the plurality of distinct fields of the transaction log record includes a field that identifies the date and time of the near field RF communication data transaction.

25. The computer program product embodied on a computer readable medium of claim 20 wherein the plurality of distinct fields of the transaction log record includes a field that identifies a financial account associated with the near field RF communication data transaction.

26. The computer program product embodied on a computer readable medium of claim 20 wherein the plurality of distinct fields of the transaction log record includes a field that identifies a monetary amount associated with the near field RF communication data transaction.

27. The computer program product embodied on a computer readable medium of claim 20 wherein the plurality of distinct fields of the transaction log record includes a field that identifies the vendor associated with the near field RF communication data transaction.

28. The computer program product embodied on a computer readable medium of claim 20 wherein the plurality of distinct fields of the transaction log record includes a field that identifies a transaction file identifier associated with the near field RF communication data transaction.

29. The computer program product embodied on a computer readable medium of claim 28 wherein the field that identifies a transaction file identifier associated with the near field RF communication data transaction includes a file name identifier.

30. The computer program product embodied on a computer readable medium of claim 28 wherein the field that identifies a transaction file identifier associated with the near field RF communication data transaction includes a file type identifier.

31. The computer program product embodied on a computer readable medium of claim 28 wherein the field that identifies a transaction file identifier associated with the near field RF communication data transaction includes a file size identifier.

32. The computer program product embodied on a computer readable medium of claim 28 wherein the field that identifies a transaction file identifier associated with the near field RF communication data transaction includes a file location identifier.

33. A portable mobile communications device for creating a transaction log of data exchanges between a portable mobile communications device and other wireless devices comprising:
a near field RF communication module for performing a near field RF communication data transaction comprised of establishing a near field RF communication connection between the portable mobile communications device and another similarly equipped wireless device, exchanging data between the portable mobile communications device and other similarly equipped wireless device over the established near field RF communication connection, and terminating the established near field RF communication connection between the portable
a near field RF communication transaction log application for creating a transaction log record of the just performed near field RF communication data transaction;
a processor for controlling the functions of the near field RF communication module and near field RF communication transaction log application; and
data storage for storing a database of transaction log records.

34. The portable mobile communications device of claim 33 wherein the near field RF communication transaction log application obtains data pertaining to the just performed near field RF communication data transaction that uniquely identifies the transaction and its context and fills a plurality of distinct fields of the transaction log record with the relevant data obtained pertaining to the just performed near field RF communication data transaction.

35. The portable mobile communications device 34 wherein the plurality of distinct fields of the transaction log record includes a field that identifies the sending wireless device involved in the data exchange.

36. The portable mobile communications device 34 wherein the plurality of distinct fields of the transaction log record includes a field that identifies the receiving wireless device involved in the data exchange.

37. The portable mobile communications device 34 wherein the plurality of distinct fields of the transaction log record includes a field that identifies the geographic location of the near field RF communication data transaction.

38. The portable mobile communications device 34 wherein the plurality of distinct fields of the transaction log record includes a field that identifies the date and time of the near field RF communication data transaction.

39. The portable mobile communications device 34 wherein the plurality of distinct fields of the transaction log record includes a field that identifies a financial account associated with the near field RF communication data transaction.

40. The portable mobile communications device 34 wherein the plurality of distinct fields of the transaction log record includes a field that identifies a monetary amount associated with the near field RF communication data transaction.

41. The portable mobile communications device 34 wherein the plurality of distinct fields of the transaction log record includes a field that identifies the vendor associated with the near field RF communication data transaction.

42. The portable mobile communications device 34 wherein the plurality of distinct fields of the transaction log record includes a field that identifies a transaction file identifier associated with the near field RF communication data transaction.

43. The portable mobile communications device 42 wherein the field that identifies a transaction file identifier associated with the near field RF communication data transaction includes a file name identifier.

44. The portable mobile communications device 42 wherein the field that identifies a transaction file identifier associated with the near field RF communication data transaction includes a file type identifier.

45. The portable mobile communications device 42 wherein the field that identifies a transaction file identifier associated with the near field RF communication data transaction includes a file size identifier.

46. The portable mobile communications device 42 wherein the field that identifies a transaction file identifier associated with the near field RF communication data transaction includes a file location identifier.
